(19) United States
(12) Patent Application Publication
(10) Pub. No.: US 2011/0062254 A1
(43) Pub. Date: Mar. 17, 2011

(54) CONTROL VALVE FOR REDUCING INJECTING AMOUNT VARIATION AND INJECTOR PROVIDED WITH THE SAME

(75) Inventor: Yongsoon PARK, Suwon-city (KR)

(73) Assignees: HYUNDAI MOTOR COMPANY, Seoul (KR); KIA MOTORS CORPORATION, Seoul (KR)

(21) Appl. No.: 12/620,918

(22) Filed: Nov. 18, 2009

(30) Foreign Application Priority Data
Sep. 15, 2009 (KR) 10-2009-0087121

(51) Int. Cl. F02M 51/06; F16K 21/00

(52) U.S. Cl. 239/585.5; 137/596.2

(57) ABSTRACT

A control valve for reducing injecting amount variation disposed under a bobbin, disposed to a solenoid valve, may include slots formed to an upper portion of the control valve to contact the bobbin for easily separated from the bobbin.

### CROSS-REFERENCE TO RELATED APPLICATION

The present application claims priority to Korean Patent Application No. 10-2009-0087121 filed on Sep. 15, 2009, the entire contents of which are incorporated herein for all purposes by this reference.

### BACKGROUND OF THE INVENTION

1. Field of the Invention

The present invention relates to a control valve and an injector provided with the same. More particularly, the present invention relates to a control valve for reducing injecting amount variation and an injector provided with the same.

2. Description of Related Art

Research and Development of a diesel engine has been investigated in exhaust control.

So unlike a gasoline engine, a diesel engine has boundaries to reduce NOx and PM using catalyst devices, so Research and Development of a diesel engine has been focused on reducing harmful exhaust gas itself.

The reason why Common Rail System is applied to a diesel engine is to reduce harmful exhaust gas itself. The common rail system is able to form high pressure such as 1800-2000 bar and to multiply inject such as 6-7 times within one power stroke-referred to as multiple injection. The multiple injection includes pilot injection, main injection and post injection.

The pilot injection is executed before the main injection for reducing noise and NOx. And the post injection is executed after the main injection for revitalizing combustion process and achieving even lower exhaust emissions, particularly when a DPF (Diesel Particulate Filter Trap) is used, the post injection may burn soot accumulated in the DPF.

Injecting amount variation of the pilot injection and the post injection has to be managed within some limits so management of injecting amount variation of the pilot injection and the post injection is the key factor.

FIG. 3 is graph showing opening delay and closing delay.

The opening delay (OD) and the closing delay (CD) indicate differences between electric opening/closing fuel signals and actual opening/closing fuel. In the drawing, after long-time operation, opening delay is not considerable; however, closing delay is increased proportional to operation duration. And increasing of the closing delay prevents from exact fuel injection so engine performance is deteriorated and harmful gas is increased.

FIG. 4 is a graph showing injecting amount variation of a control valve according to a conventional art.

As shown in FIG. 4, after about 30 hours operation of an injector, injecting amount variation is increased more than 1 mm³/str (1 mm³ per stroke). In this case, it is preferable that fuel variation per stroke has to be limited within 0.4 mm³/str.

In the experiment the fuel is premium fuel that is added in additives. The premium fuel is added in cetane number improver for increasing fuel efficiency, detergent for cleaning system, cold flow improver and so on. In the additives, it is turned out that the detergent forms adhesive lacquer deposit.

The adhesive lacquer deposit is formed between a bobbin, which is disposed under a solenoid valve and plays the role of a stopper, and a control valve, and the adhesive lacquer deposit retards return of the control valve so variation of fuel injection amount is increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a control valve for reducing injecting amount variation and an injector provided with the same by preventing from generating adhesive lacquer deposit in the control valve so as to decrease closing delay.

In an aspect of the present invention, the control valve for reducing injecting amount variation disposed under a bobbin, disposed to a solenoid valve, may include slots formed to an upper portion of the control valve to reduce a contact area of the control valve to the bobbin for being easily separated from the bobbin, wherein the slots are formed along circumferential direction of the control valve, wherein a depth of the slot is approximately 10 μm to approximately 30 μm, wherein the slots are formed along radial direction of the control valve, and wherein a depth of the slot is approximately 10 μm to approximately 30 μm.

In another aspect of the present invention, the injector may include a bobbin disposed under a solenoid valve, and a control valve disposed under the bobbin and configured to repeat contacting and separating from the bobbin, wherein slots are formed to an upper portion of the control valve, wherein the slots are formed along circumferential direction of the control valve, wherein a depth of the slot is approximately 10 μm to approximately 30 μm, wherein the slots are formed along radial direction of the control valve, wherein a depth of the slot is approximately 10 μm to approximately 30 μm, and wherein the injector further includes: an injector housing provided with the solenoid valve, the bobbin and the control valve therein, an injector needle disposed within the injector housing, a needle return spring for supplying restoring force to the injector needle, an upper chamber where the needle return spring is disposed, and an orifice connecting the upper chamber and the control valve, wherein the control valve repeats closing and opening the orifice.

In further another aspect of the present invention, the injector may include an upper body mounted in an injector housing and provided with a solenoid valve therein, a bobbin disposed under the solenoid valve in the upper body, a control valve disposed under the bobbin in a control chamber formed in the upper body, wherein at least a slot is formed to an upper portion of the control valve and the control valve is selectively movable by the solenoid valve in the control chamber, an injector needle disposed in an injector passage of a lower body mounted in the injector housing and selectively blocking a nozzle formed at an end portion of the injector passage in the lower body, a needle return spring for supplying restoring force to the injector needle, an upper chamber where the needle return spring is disposed therein, and an orifice connecting the upper chamber and the control chamber, wherein a fuel supply line is formed in the upper and lower bodies and fluidly-connected to the injector passage, and wherein the control valve is configured to selectively open the orifice when the control valve is activated by the solenoid valve, wherein the at least a slot is formed along circumferential direction of the control valve, wherein a depth of the at least a slot is approximately 10 μm to approximately 30 μm, wherein the at least a slot is formed along radial direction of the control valve, and wherein a depth of the at least a slot is approximately 10 μm to approximately 30 μm.

In various aspects of the present invention, a control valve for reducing injecting amount variation and an injector provided with the same may have slots in a control valve in order to reduce closing delay so exact fuel injection may be achieved, engine performance may be enhanced and harmful exhaust gas may be reduced.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a cross-sectional view of an injector according to an exemplary embodiment of the present invention.

FIG. 2 is a drawing showing an upper portion of a control valve according to an exemplary embodiment of the present invention.

FIG. 3 is graph showing opening delay and closing delay.

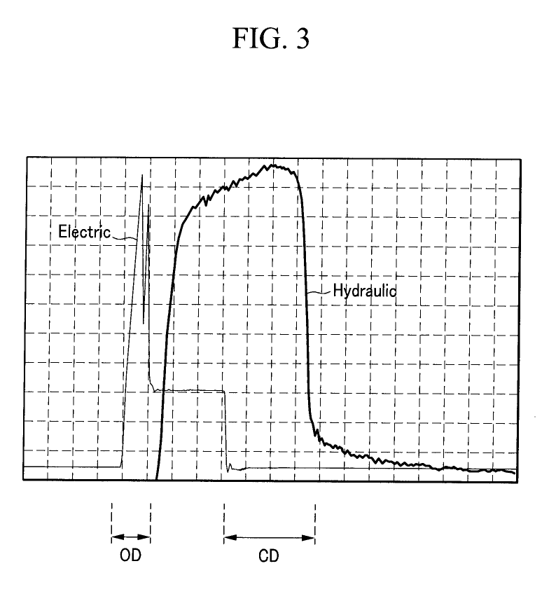

FIG. 4 is a graph showing injecting amount variation of a control valve according to a conventional art.

FIG. 5 is a graph showing injecting amount variation of a control valve according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

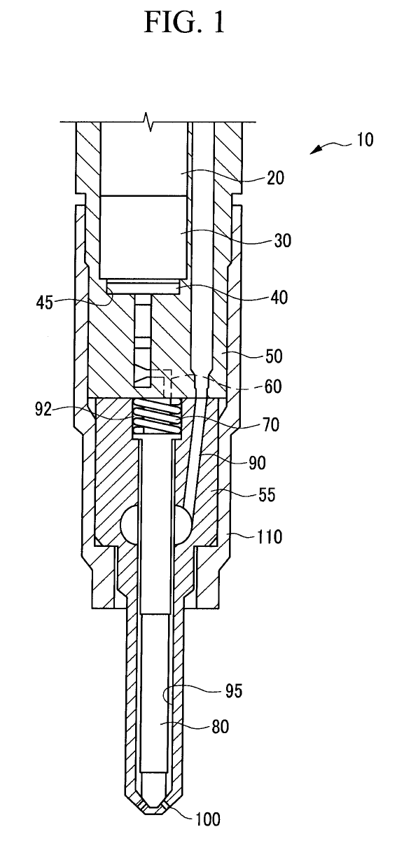

FIG. 1 is a cross-sectional view of an injector according to an exemplary embodiment of the present invention.

Hereinafter, scheme and operations of an injector 10 will be described.

An ECU (electronic control unit; not shown) controls a solenoid valve 20 disposed within an injector housing 110 according to engine operations, a bobbin 30 playing a role of a stopper is disposed under the solenoid valve 20 and a control valve 40 is disposed under the bobbin 30 in a control chamber 45.

An injector needle 80 is disposed under the control valve 40 and the injector needle 80 is elastically supported by a needle return spring 70.

A fuel supply line 90 is formed in upper and lower bodies 50 and 55 for supplying fuel toward the injector needle 80. The upper and lower bodies 50 and 55 are installed in the injector housing 110.

The fuel supply line 90 supplies high-pressed fuel toward the injector needle 80, the injector needle 80 blocks a nozzle 100 by elastic force of the needle return spring 70 and the control valve 40 is minutely set apart from the bobbin 30.

When the ECU outputs fuel supply signal to the solenoid valve 20, the solenoid valve 20 moves the control valve 40 slightly up and the control valve 40 contacts the bobbin 30.

The control valve 40 and an upper chamber 92, where the needle return spring 70 located, are connected by an orifice 60. The orifice 60 connects the upper chamber 92 with the control chamber 45. By the operation of the control valve 40, the orifice 60 is opened and balance of pressure between the chamber 92 and the fuel supply line 90 is upset.

Then the injector needle 80 mounted in an injector passage 95 formed in the lower body 55 moves upward in the drawing and the nozzle 100 is opened to inject the fuel.

And then the solenoid valve 20 separates the control valve 40 from the bobbin 30 and the orifice 60 is closed. Thus the injector needle 80 closes the nozzle 100 by the elastic force of the needle return spring 70.

The more the fuel injection process is repeated, the more adhesive lacquer deposit is formed between the bobbin 30 and the control valve 40 so that the adhesive lacquer deposit retards return of the control valve 40.

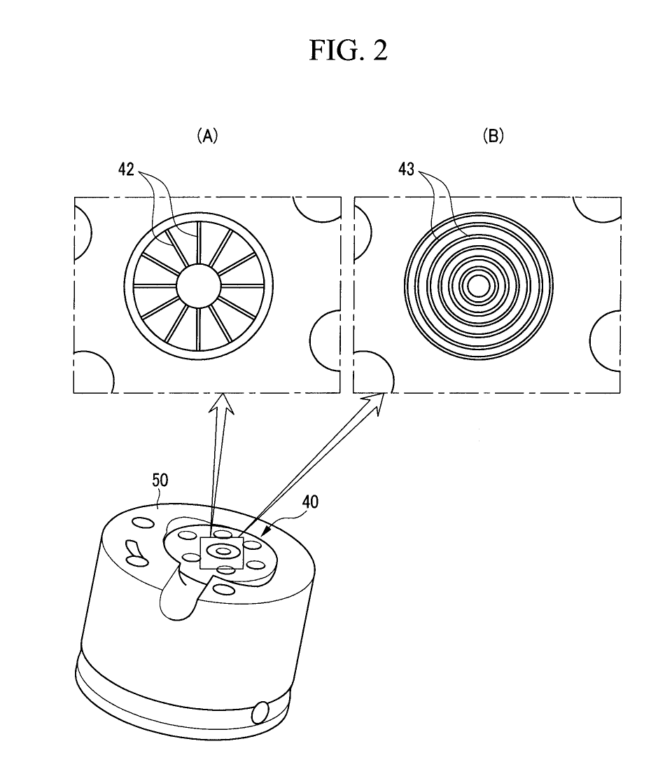

FIG. 2 is a drawing showing an upper portion of a control valve according to an exemplary embodiment of the present invention.

As shown in FIG. 2(A), in an exemplary embodiment of the present invention slots 42 are formed to the control valve 40.

The slots 42 are formed along circumferential direction of the control valve 40 and a depth of the slot 42 is 10 μm to 30 μm.

In an exemplary embodiment of the present invention, if the depth of the slot 42 is about 20 μm, area of the control valve 40 that contacts the bobbin 30 is reduced about 20%.

With the slots 42, generating of the adhesive lacquer deposit can be suppressed and influence of the adhesive lacquer deposit can be reduced.

Referring FIG. 2(B), modified slots 43 are shown. The slots 43 according to an exemplary modified embodiment of the present invention are formed along radial direction of the control valve 40 and functions and effects of the slots 43 is the same as the slots 42 shown in FIG. 2(A) so detailed description will be omitted.

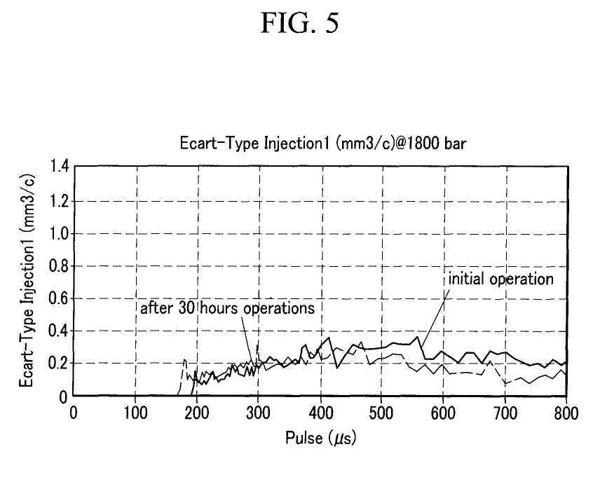

FIG. 5 is a graph showing injecting amount variation of a control valve according to an exemplary embodiment of the present invention.

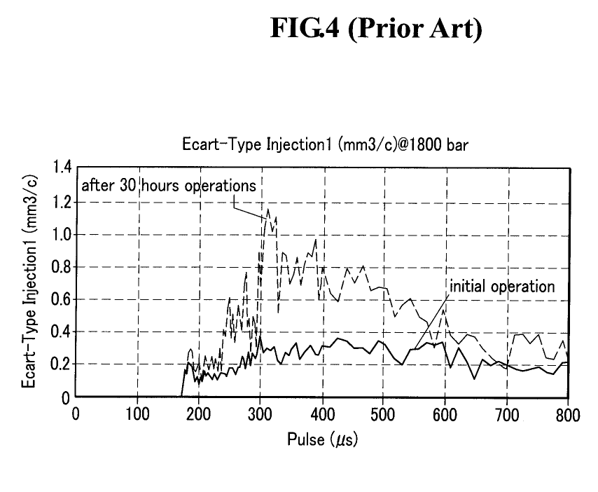

Comparing FIG. 4 and FIG. 5, the injecting amount variation of the control valve 40 provided with the slot 42 according to an exemplary embodiment of the present invention remains within preferable ranges (for example within 0.4 mm³/str).

Thus, the control valve with the slot according to an exemplary embodiment of the present invention and the injector provided with the same may reduce influence of the adhesive lacquer deposit and closing delay (CD) so that variation injecting fuel amount can be reduced.

Also, engine performance may be improved and noxious exhaust gas can be reduced.

For convenience in explanation and accurate definition in the appended claims, the terms “upper” and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A control valve for reducing injecting amount variation disposed under a bobbin, disposed to a solenoid valve, the control valve comprising:
slots formed to an upper portion of the control valve to reduce a contact area of the control valve to the bobbin for being easily separated from the bobbin.

2. The control valve of claim 1, wherein the slots are formed along circumferential direction of the control valve.

3. The control valve of claim 2, wherein a depth of the slot is approximately 10 μm to approximately 30 μm.

4. The control valve of claim 1, wherein the slots are formed along radial direction of the control valve.

5. The control valve of claim 4, wherein a depth of the slot is approximately 10 μm to approximately 30 μm.

6. An injector comprising:
a bobbin disposed under a solenoid valve; and
a control valve disposed under the bobbin and configured to repeat contacting and separating from the bobbin,
wherein slots are formed to an upper portion of the control valve.

7. The injector of claim 6, wherein the slots are formed along circumferential direction of the control valve.

8. The injector of claim 7, wherein a depth of the slot is approximately 10 μm to approximately 30 μm.

9. The injector of claim 6, wherein the slots are formed along radial direction of the control valve.

10. The injector of claim 9, wherein a depth of the slot is approximately 10 μm to approximately 30 μm.

11. The injector of claim 6, wherein the injector further comprises:
an injector housing provided with the solenoid valve, the bobbin and the control valve therein;
an injector needle disposed within the injector housing;
a needle return spring for supplying restoring force to the injector needle;
an upper chamber where the needle return spring is disposed; and
an orifice connecting the upper chamber and the control valve,
wherein the control valve repeats closing and opening the orifice.

12. An injector comprising:
an upper body mounted in an injector housing and provided with a solenoid valve therein;
a bobbin disposed under the solenoid valve in the upper body;
a control valve disposed under the bobbin in a control chamber formed in the upper body, wherein at least a slot is formed to an upper portion of the control valve and the control valve is selectively movable by the solenoid valve in the control chamber;
an injector needle disposed in an injector passage of a lower body mounted in the injector housing and selectively blocking a nozzle formed at an end portion of the injector passage in the lower body;
a needle return spring for supplying restoring force to the injector needle;
an upper chamber where the needle return spring is disposed therein; and
an orifice connecting the upper chamber and the control chamber,
wherein a fuel supply line is formed in the upper and lower bodies and fluidly-connected to the injector passage, and
wherein the control valve is configured to selectively open the orifice when the control valve is activated by the solenoid valve.

13. The injector of claim 12, wherein the at least a slot is formed along circumferential direction of the control valve.

14. The injector of claim 13, wherein a depth of the at least a slot is approximately 10 μm to approximately 30 μm.

15. The injector of claim 12, wherein the at least a slot is formed along radial direction of the control valve.

16. The injector of claim 15, wherein a depth of the at least a slot is approximately 10 μm to approximately 30 μm.
